(19) United States
(12) Patent Application Publication
(10) Pub. No.: US 2018/0205272 A1
(43) Pub. Date: Jul. 19, 2018

(54) STATOR RING, GENERATOR AND WIND TURBINE EQUIPPED THEREWITH

(71) Applicant: Wobben Properties GmbH, Aurich (DE)

(72) Inventors: Albrecht BRENNER, Aurich (DE); Frank KNOOP, Aurich (DE); Jan Carsten ZIEMS, Aurich (DE)

(21) Appl. No.: 15/744,669

(22) PCT Filed: Jun. 21, 2016
(86) PCT No.: PCT/EP2016/064290

§ 371 Date: Jan. 12, 2018

(30) Foreign Application Priority Data
Jul. 17, 2015 (DE) 10 2015 213 514.4

(51) Int. Cl. H02K 1/20; H02K 1/16; H02K 7/18; H02K 9/04; F03D 9/25

(52) U.S. Cl. CPC H02K 1/20; H02K 1/16; H02K 7/1838; F05B 2260/222; F03D 9/25; F05B 2240/912; F05B 2220/7066; H02K 9/04

(57) ABSTRACT

A stator ring for an electric generator having a plurality of grooves for receiving the stator winding, and a magnetic yoke. A stator ring which has a plurality of cooling recesses through which cooling air can flow in the region of the magnetic yoke, wherein the stator ring has a plurality of stator plates which are stacked in succession in the axial direction of the stator ring, wherein the cooling recesses extend through all stator plates.

### BACKGROUND

### Technical Field

The present invention concerns a stator ring for an electric generator, in particular a synchronous generator or a ring generator of a wind turbine. The invention further concerns such a synchronous generator or ring generator. In addition the invention concerns a wind turbine having such a generator.

### Description of the Related Art

Stator rings of the above-indicated kind are basically known. They usually have a large number of grooves for receiving the stator winding, in which electric power is induced by the rotor moving along the winding. The stator rings are typically of such a structure that they have a magnetic yoke adjacent to the portion which carries the grooves. In the case of stator rings for internal rotors the magnetic yoke is disposed radially outside the region in which the grooves are provided. In the case of stator rings for external rotors the situation is correspondingly reversed. Here the grooves are radially outside the magnetic yoke.

As a consequence of the induction of electrical power heat is generated in an electric generator of the above-indicated kind, in particular in the stator ring. In order to keep the power losses caused thereby as low as possible efficient heat dissipation is desirable.

Various approaches for also directly dissipating heat from the stator ring are known from the state of the art. For example citation EP 2 419 991 B1 discloses the use of tubes which extend through the stator ring and are hydraulically expanded to be applied firmly in the recesses, this being intended to provide for better heat transfer. While cooling in accordance with the procedure referred to by way of example hereinbefore is generally deemed to be operable in practice nonetheless the required apparatus expenditure and also the amount of time required for fitting the tubes and for expanding the tubes is found to be a disadvantage. In addition in the case of some types of generator there is the possibility of operating with air cooling instead of liquid cooling.

A principle involved in air cooling is known for example from WO 2010/040659 A2. It is proposed therein that a plurality of cooling passages which have a radial afflux flow are provided in an outer carrier structure of the stator ring, which cooling passages cooperate with a stator bell for providing a pressure chamber with an increased pressure or a reduced pressure to provide an air flow. The cooling concept set forth therein is deemed to be satisfactory in terms of its mode of operation. Nonetheless there is still a need to further improve the cooling efficiency aspects in a generator and a stator of the kind set forth in opening part of this specification.

### BRIEF SUMMARY

Provided is a stator ring with an improved possibility of cooling.

In particular at least one embodiment of the stator ring has a plurality of grooves for receiving the stator winding, and a magnetic yoke adjacent to the grooves, wherein the stator ring in the region of the magnetic yoke has a plurality of cooling recesses through which cooling air can flow and wherein the stator ring has a plurality of stator plates which are stacked in succession in the axial direction of the stator ring, wherein the cooling recesses extend through all stator plates.

The magnetic yoke preferably has a first region directly adjacent to the grooves, and a radially further outwardly disposed second region which is referred to as an enlarged magnetic yoke. In a preferred configuration the cooling recesses are arranged in the enlarged magnetic yoke.

Heat dissipation is effected at its most efficient where it occurs.

The higher efficiency in terms of heat dissipation compensates for the power losses which are accepted due to the disturbances, which arise in particular out of the preferred developments of the invention.

An advantageous provides that cooling ribs for increasing the surface area are provided in one, more of all of the cooling recesses.

In a preferred embodiment the cooling recesses are in the form of slots. Preferably the long sides of the slots extend in the radial direction of the stator ring. The term slot is also used in accordance with the invention to mean those recesses, the ends of which are not of a semicircular configuration. Therefore recesses of a rectangular cross-section, possibly also with rounded corners, are also deemed to be slots.

Preferably at least two cooling recesses of the plurality of cooling recesses are separated from each other by a web, the highest thickness of which in the peripheral direction of the stator ring is preferably equal to or less than the internal width of the cooling recesses in the peripheral direction. The web which is dimensioned in that way therefore also functions as a cooling rib, in addition to its supporting function.

In a preferred embodiment the stator ring has a plurality of sets each comprising at least two cooling recesses separated from each other by a web. In preferred alternative embodiments there is preferably one set for each third groove or particularly preferably one set for each second groove or alternatively and particularly preferably one set for each groove.

The spacing between two sets of cooling recesses is preferably greater than the spacing between two cooling recesses which are adjacent within a set.

The highest thickness of the web between two cooling recesses within a set in the peripheral direction of the stator ring is preferably equal to or less than the internal width of the cooling recesses in the peripheral direction.

In a further preferred embodiment of the stator ring the cooling recesses are arranged displaced in the peripheral direction relative to the grooves. The displaced arrangement of the cooling recesses relative to the grooves provides for a very uniform flow of heat, when the cooling recess is of a sufficiently large size.

In a preferred embodiment of the stator ring the surface of the cooling recesses is contoured in such a way that the production of turbulence effects within the cooling recesses is promoted. The formation of a turbulent air flow within the cooling recesses provides for an increase in the heat transfer from the air to the surface of the cooling recesses. Preferably the contour in the configuration having a plurality of stator plates stacked in succession is produced by means of a displacement in a radial direction and/or in a peripheral direction of the cooling recesses between adjacent stator plates. By virtue of the displacement, the surface of the cooling recesses is roughened, when considered technically.

In a further aspect the invention concerns an electric generator, in particular a synchronous generator or ring generator of a wind turbine, having a rotor and a stator, wherein the stator has a stator ring. In accordance with that aspect the stator ring is designed in accordance with one of the above-described preferred embodiments.

In a first preferred embodiment of the generator the rotor is in the form of an internal rotor. In a second preferred embodiment the rotor of the generator is in the form of an external rotor.

In a further aspect the present invention concerns a wind turbine, in particular a gear-less wind turbine, having an electric generator, in particular a synchronous generator or ring generator. In the case of such a wind turbine the generator is designed in accordance with one of the embodiments described herein.

Preferably the wind turbine has at least one motor-driven, preferably electric motor-driven fan for producing a cooling air flow through the cooling recesses of the stator ring.

### BRIEF DESCRIPTION OF THE SEVERAL VIEWS OF THE DRAWINGS

The invention is described in greater detail hereinafter by means of preferred embodiments with reference to the accompanying Figures in which:

FIG. 1 is a diagrammatic perspective view of a wind turbine,

FIG. 2 is a diagrammatic perspective sectional view of a pod of the wind turbine of FIG. 1,

FIG. 3 is a simplified diagrammatic perspective view of a stator of the wind turbine shown in FIGS. 1 and 2,

FIG. 4 is a partial diagrammatic sectional view through the stator shown in FIG. 3,

FIG. 4a is a partial view of FIG. 4 concerning the magnetic yoke,

FIG. 5 shows a partial diagrammatic detail view of FIG. 4 for a first embodiment,

FIG. 6 shows a partial diagrammatic detail view of FIG. 4 for a second embodiment, and

FIG. 7 shows a sectional view along line A-A in FIG. 1.

### DETAILED DESCRIPTION

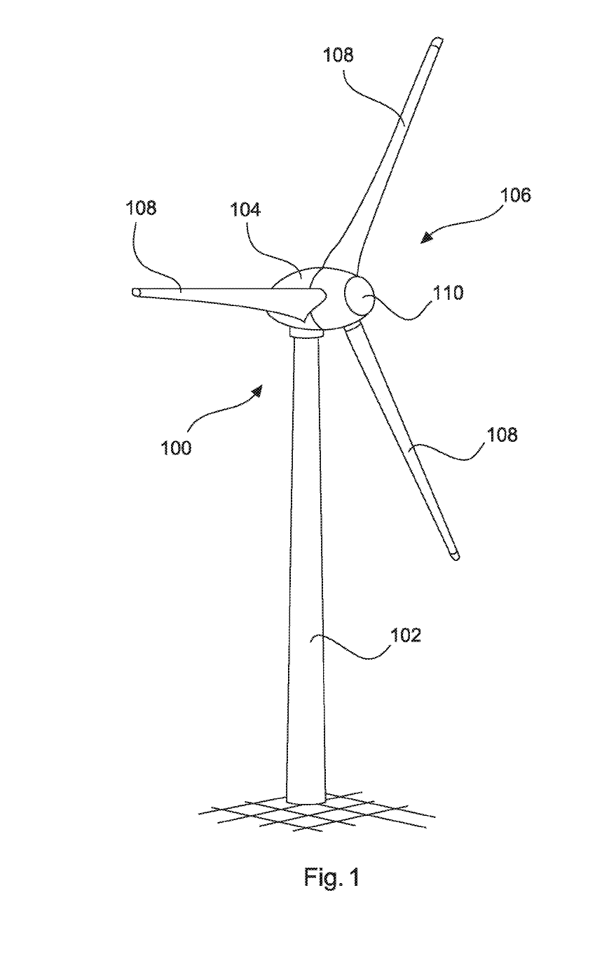

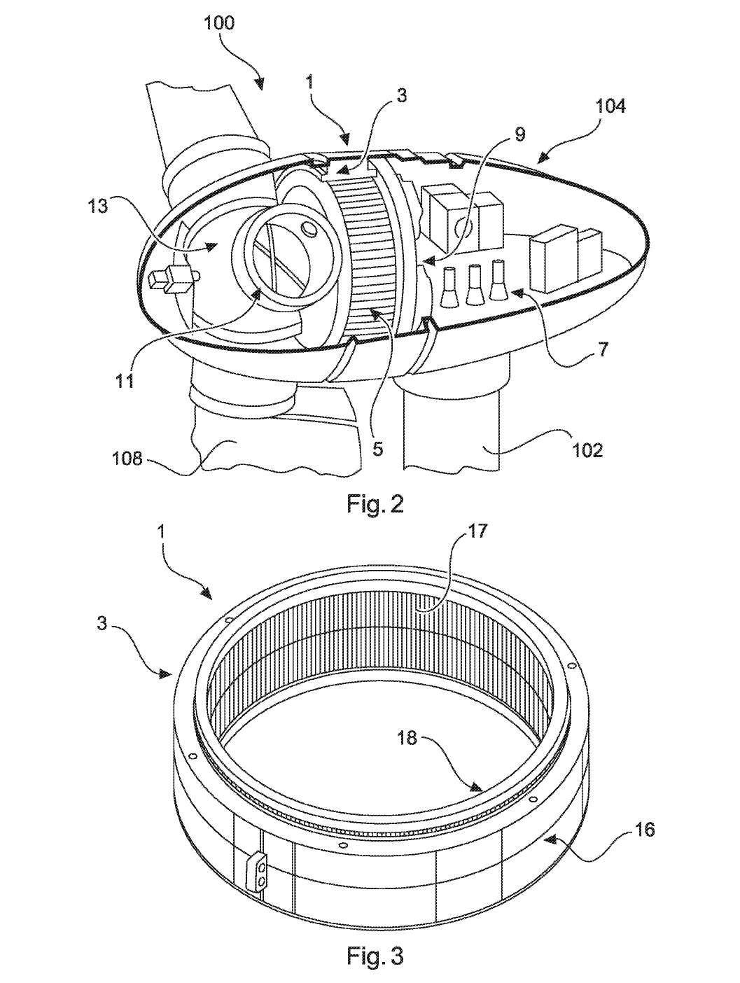

FIG. 1 shows a wind turbine 100 having a tower 102 and a pod 104. Arranged at the pod 104 is a rotor 106 having three rotor blades 108 and a spinner 110. The rotor 106 is caused to rotate by the wind in operation and thereby drives a generator 1 (FIG. 2) in the pod 104.

The pod 104 is shown in FIG. 2. The pod 104 is mounted rotatably to the tower 102 and connected in driven relationship in generally known manner by means of an azimuth drive 7. In also generally known manner provided in the pod 104 is a machine carrier 9 which holds a synchronous generator 1. The synchronous generator 1 is designed in accordance with the present invention and is in particular a slowly rotating, multi-pole synchronous ring generator. The synchronous generator 1 has a stator 3 and an internal rotor 5, also referred to as the rotor member of the generator. The rotor or rotor member 5 is connected to a rotor hub 13 which transmits the rotational movement of the rotor blades 108, caused by the wind, to the synchronous generator 1.

FIG. 3 shows the stator 3 on its own. The stator 3 has a stator ring 16 having an inner peripheral surface 18. Provided in the inner peripheral surface 18 is a plurality of grooves 17 which are adapted to receive the stator winding in the form of conductor bundles.

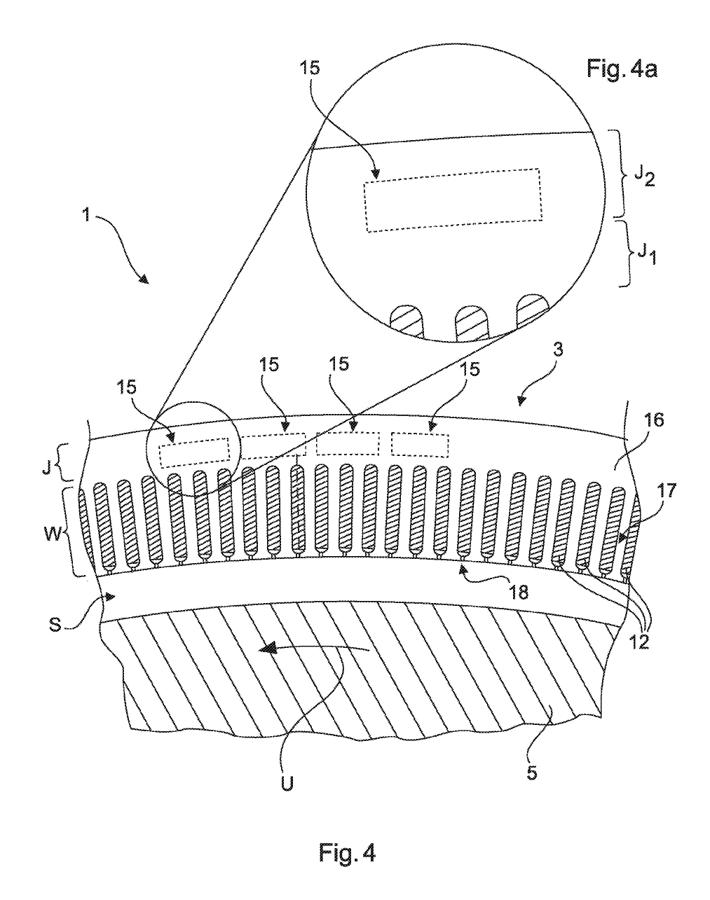

As can be seen from the cross-sectional view in FIG. 4 the stator ring 16 of the stator 3 has a stator winding in a first radial region W. The stator winding is disposed in the form of conductor bundles 12 in the grooves 17 which extend from the inner peripheral surface 18. The magnetic yoke J is provided adjacent to the region W. In the case of the illustrated generator 1 with an internal rotor, indicated by a rotor 5 which moves in the peripheral direction U within the stator ring 16, the magnetic yoke J is radially outside the region W having the stator winding. In an alternative generator which is also in accordance with the invention and having an external rotor (not shown), the rotor would rotate radially outside the stator and accordingly the magnetic yoke would be arranged radially within the region of the stator windings adjacent thereto. An additional view has been dispensed with at this juncture for the sake of clarity. An air gap S is provided between the stator 3 and the rotor 5.

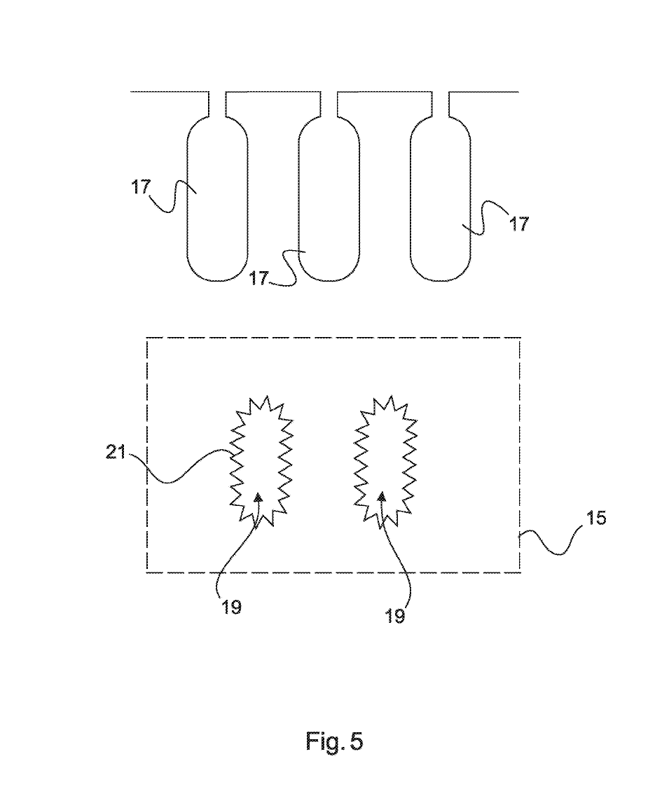

A plurality of sets 15 of cooling recesses 19 (see FIGS. 5 and 6) are provided in the stator ring 16 in the region J of the magnetic yoke. A set 15 of cooling recesses can include one or more cooling recesses. A respective set of cooling recesses can be respectively provided for one, two, three, four or more than four grooves.

The diagrammatic partial view in FIG. 4a shows the division of the magnetic yoke J into a first region J1 and a radially outwardly adjoining second region J2. The second region J2 is interpreted as the enlarged magnetic yoke. The cooling recesses are preferably arranged in the second region J2. In the present embodiment by way of example a respective set 15 of cooling recesses is associated with three grooves.

FIGS. 5 and 6 show various details of the invention in isolation from each other. It is assumed in accordance with the invention however that the individual features which are respectively shown only in one of the embodiments by way of example can also be combined with the features of the other embodiments. FIGS. 5 and 6 do not show a curvature of the stator ring 13. The illustrated details apply both to generators with an internal rotor and also with an external rotor.

FIG. 5 firstly shows a set 15 comprising two cooling recesses 19. The cooling recesses 19 are spaced from each other in the peripheral direction and are arranged in displaced relationship with the grooves 17. Each of the recesses 19 shown in FIG. 5 has a plurality of cooling ribs 61.

FIG. 6 shows in total three sets 15 respectively having two cooling recesses 19, wherein each set 15 is associated with a groove 17. The sets 15 with the cooling recesses 19 are not displaced relative to the grooves 17 respectively associated therewith.

The cooling recesses 19 within a respective set are spaced from each other by a thin web 20. As its widest location the web 20 is of a thickness 23 which is less than a spacing 25 between the cooling recesses 19 of adjacent sets. Preferably the width 23 of a respective web is less than or equal to the width in the peripheral direction of one of the cooling recesses 19.

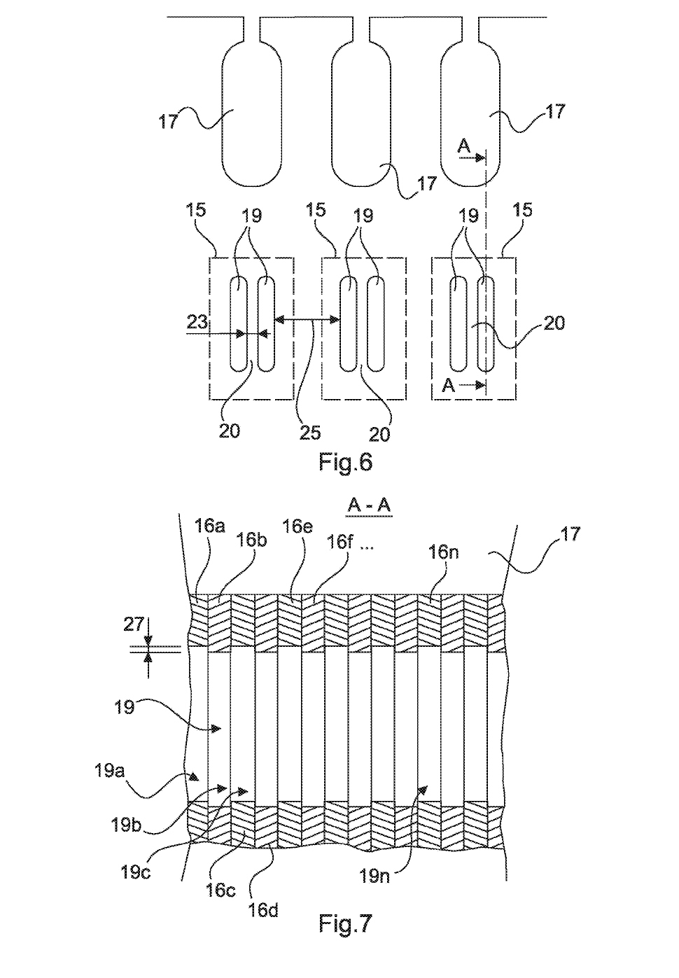

FIG. 7 shows a section along line A-A in FIG. 6. The stator plate packets 16a, 16b, 16c, 16d, 16e, 16f, . . . 16n are displaced relative to each other in the radial direction in such a way that the inner surface of the cooling recess 19 is roughened. The displacement 27 can be slight. A displacement of a few millimeters already promotes heat exchange between the cooling air in the cooling recess 19 and the stator plates 16a-16n. The stator plates overall do not have to be displaced relative to each other, for such a configuration. It is sufficient if the respective cooling recesses 19a-19n which extend through the individual plates 16a-16n are slightly displaced relative to each other.

As can be seen from the foregoing the cooling recesses 19 can be of a smooth-walled configuration as shown in FIG. 5. Equally the cooling recesses 19 could be provided with cooling ribs as shown in FIG. 6. More than two cooling recesses can be provided within a set 15 of cooling recesses, and a set 15 of cooling recesses 19 can be associated with a number of grooves 17, differing from FIGS. 5 and 6.

1. A stator ring for an electric generator, of a wind turbine comprising:
a plurality of grooves for receiving the stator winding; and
a magnetic yoke,
wherein the stator ring in a region of the magnetic yoke has a plurality of cooling recesses through which cooling air is able flow, wherein the stator ring has a plurality of stator plates stacked in succession in an axial direction of the stator ring, wherein the plurality of cooling recesses extend through all of the plurality of stator plates, and wherein each surface of the plurality of cooling recesses is of such a contour that production of turbulence within the plurality of cooling recesses is promoted.

2. The stator ring according to claim 1, further comprising cooling ribs in at least one of the plurality of cooling recesses to increase an area of the surface of the respective cooling recess.

3. The stator ring according to claim 1, wherein the plurality of cooling recesses are in slots.

4. The stator ring according to claim 1 wherein at least two of the plurality of cooling recesses are separated from each other by a web.

5. The stator ring according to claim 1 wherein the stator ring has a plurality of sets, each set comprising at least two adjacent cooling recesses separated from each other by a web.

6. The stator ring according to claim 5, wherein a spacing between two adjacent sets is greater than a spacing between two adjacent cooling recesses within a set.

7. The stator ring according to claim 1 wherein the plurality of cooling recesses are arranged displaced in a peripheral direction relative to the plurality of grooves.

8. (canceled)

9. An electric generator of a wind turbine the electric generator comprising:
a rotor and a stator, wherein the stator has a stator ring, wherein the stator ring includes:
a plurality of grooves for receiving the stator winding; and
a magnetic yoke,
wherein, in a region of the magnetic yoke, the stator ring has a plurality of cooling recesses through which cooling air is able flow, wherein the stator ring has a plurality of stator plates stacked in succession in an axial direction of the stator ring, wherein the plurality of cooling recesses extend through all of the plurality of stator plates, and wherein each surface of the plurality of cooling recesses is of such a contour to promote turbulent air flow of the cooling air.

10. The electric generator according to claim 9, wherein the rotor is an internal rotor.

11. The electric generator according to claim 9, wherein the rotor is an external rotor.

12. A wind turbine, comprising:
a tower;
a pod on the tower; and
an electric generator supported by the pod, wherein the electric generator is the electric generator according to claim 9.

13. The wind turbine according to claim 12, comprising at least one motor-driven fan for producing a cooling air flow through the plurality of cooling recesses of the stator ring.

14. The wind turbine according to claim 13, wherein the motor driven fan is electric motor-driven.

15. The wind turbine of claim 12, wherein the wind turbine is a gear-less wind turbine.

16. The stator ring according to claim 1, wherein the electric generator is a synchronous generator or ring generator.

17. The stator ring according to claim 9, wherein the electric generator is a synchronous generator or ring generator.
